(19) United States
(12) Patent Application Publication
(10) Pub. No.: US 2006/0184921 A1
(43) Pub. Date: Aug. 17, 2006

(54) Program management in hardware/software environment

(75) Inventors: Olof Mases, Osterskar (SE); Andreas Lalloo, Solna (SE)

Correspondence Address: NIXON & VANDERHYE, PC, 901 NORTH GLEBE ROAD, 11TH FLOOR, ARLINGTON, VA, 22203, US

(73) Assignee: Appmind Software AB, Stockholm (SE)

(21) Appl. No.: 11/334,737

(22) Filed: Jan. 19, 2006

Related U.S. Application Data
(60) Provisional application No. 60/651,992, filed on Feb. 14, 2005.

(51) Int. Cl. G06F 9/44

(52) U.S. Cl. 717/130

(57) ABSTRACT

A method for managing a program in a hardware/software environment is disclosed. The method comprises the steps of dynamically instrumenting the program, intercepting communications between the program and the hardware/software environment, and utilise the intercepted communication in the management of the program.

This application is a new U.S. utility application claiming priority to U.S. Provisional Application No. 60/651,992 filed Feb. 14, 2005, the entire content of which is hereby incorporated by reference in this application.

### TECHNICAL FIELD

The present application relates to a method for managing a program in a hardware/software environment.

The present invention also relates to a computer program product for managing a program in a hardware/software environment.

### BACKGROUND ART

Managing programs may involve one or several procedures such as monitoring of programs and program behaviour, generating alarms, controlling programs, shutting down programs, restart programs, etc. and is useful in many hardware/software related applications.

One known way of managing programs is called instrumentation and can be regarded as a sub-program or routine embedded into the program itself. Instrumentation therefore requires that the source code is known and may also require compiling in order for the instrumentation to operate properly.

Another known way of monitoring programs is called log file scanning and essentially involves scanning data that has been written on a disc from the program. Log file scanning is demanding on hardware resources. Normally, log file scanning is therefore only done at intervals, which of course increases the time to find errors or similar in the programs behaviour. If such time delay is shortened by performing the log file scanning more frequently, the demand on the hardware resources increases.

For many programs and applications it is essential that real-time or essentially real-time monitoring can be performed without impeding on system performance. Every second of delay before an action is taken (alarm, shutting down or re-start of a program, etc) could be costly.

A need therefore exists for a more general method or means for monitoring or handling processes and process behaviour that does not require any knowledge of source codes or compiling and does not involve resource-demanding features such as log file scanning.

### DISCLOSURE OF THE INVENTION

The present invention provides a method for managing a program in a hardware/software environment comprising the steps of dynamically instrumenting the program, intercepting communications between the program and other parts of the hardware/software environment, and utilise the intercepted communications in the management of the program. This method includes the capability of controlling the application.

Hooking into a program allows the managing system to alter the program with respect to its communication with the hardware/software environment. Thereby all or specific communications made by the program can effectively be intercepted. The intercepted communications are then utilised in the management of the program, e.g. by monitoring the intercepted communications certain patterns can be looked for in order to determine either malfunction of the program, generating an alarm, or for expected results to verify correct behaviour.

Alternately or complementary the managing function could be to restart a program, shut down a program or any other control of the program operation.

Yet another alternative or complement is to measure data related to use of hardware/software environment resources in connection with the program communication, enabling a full determination of e.g. program efficiency (use of OS functions, latencies, disk write times and frequency, etc.).

The present invention also provides for a computer program product comprising a computer usable medium having computer readable code therein for dynamically instrumenting a program in a hardware/software environment, intercepting communications between said program and other parts of the hardware/software environment, monitoring said intercepted communications, and initialise an action upon detection of specified content in said intercepted communication.

### BRIEF DESCRIPTION OF THE DRAWINGS

The invention will be described in more detail with reference to the appended drawings in which:

FIG. 1 shows a computer/server environment as an example of an environment, in which a managing system according to the invention may operate,

FIG. 2 shows an embodiment symbolising one embodiment of establishing a hooking of a program,

FIG. 3 shows an embodiment indicating the effect of hooking communications, and

FIG. 4 shows an embodiment indicating how the managing system handles the intercepted communications.

### EMBODIMENTS

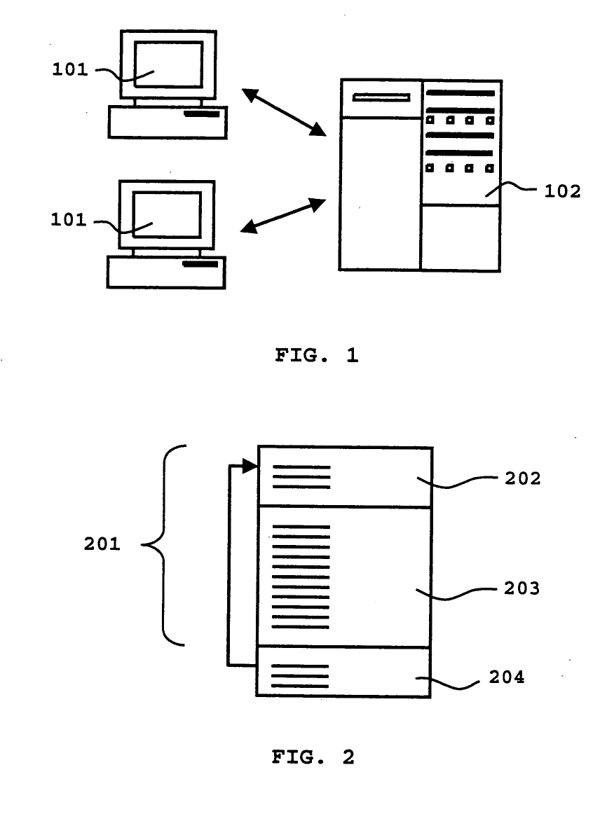

FIG. 1 shows a typical computer/server environment, with terminals 101 connected to a server 102 via internet or some other connection. Applications can be run on one or more of the units by programs. The programs can be written in any known open-source language or a language with undisclosed source code.

Especially when numerous terminals 101 are interconnected with numerous servers 102 the amount of communication between programs and the other parts of the environment is huge. It is thus of interest to supervise or manage different programs in this environment to obtain high level of operability.

One known way of doing this is to read the disks to see all logged events and based on this determine whether a program has malfunctioned or not. Such reading of a disk is very demanding on the overall system. In order to obtain a high level on up-dates, frequent reading would be required, which would put unreasonable demands on the system architecture. Real-time managing is virtually impossible to obtain. Therefore this method is characterised as being reactive.

In certain applications, a real-time management of the program is however necessary due to costs during failure of the system. For instance, a system dealing with financial transactions handles large amounts of money every second. This means that every second the system is down costs large amounts of money.

Another way of managing programs, which provides real-time monitoring of programs, is known as instrumenting. Basically, this means that a supervision program is interlaced with the program on source code level, enabling al kinds of managing possibilities. This method is characterised as being proactive since it can detect problems before they occur by analysing flows.

One drawback of this is the requirement of access to the source code of the program. Re-compiling etc may also be necessary.

The managing system according to the present invention uses a technique known as dynamic instrumentation in order to achieve a much more efficient monitoring than reading logs from disc, while not requiring knowledge of the source code of the program to be managed. Through dynamic instrumentation communications between the program and the environment can be intercepted in a way that is almost completely unnoticeable to the overall operation of the program and the other parts of the environment (specifically the operating system (OS)). The intercepted communications can be monitored to identify certain patterns or instructions. Such patterns and instructions may be pre-selected or set by an operator for optimal monitoring in each situation.

FIG. 2 shows an embodiment describing how a hooking for intercepting communications may be made for a program, resulting in dynamic instrumentation.

Essentially, the program 201 includes a first block 202 for enabling the program to interact with the OS and other parts of the external environment of the program 201 and a second block 203 comprising the actual coding of the program in a compiled state, making the original source code unavailable for normal instrumentation.

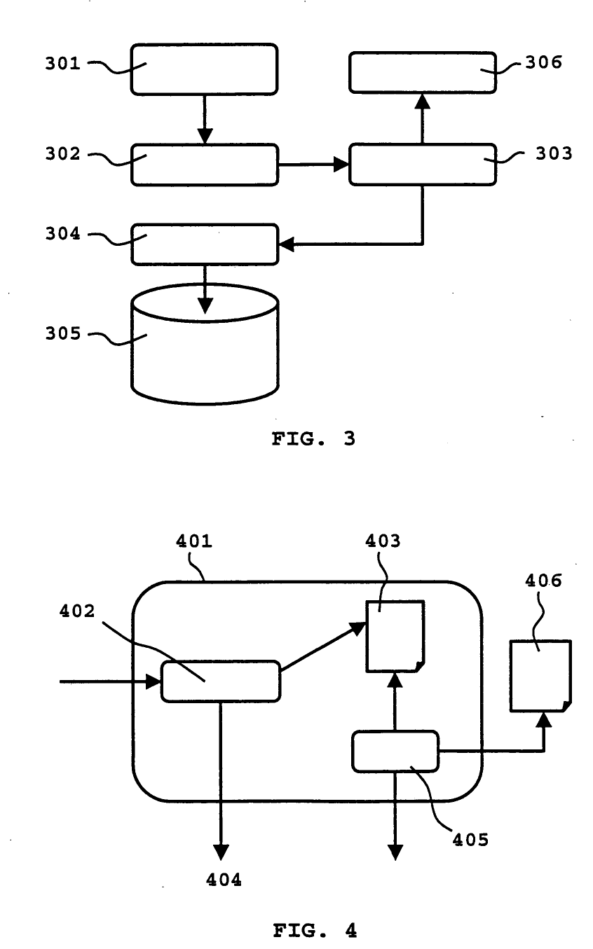

The managing system according to the invention may include a dynamic instrumentation block 204, which is injected into the program 201 and hooks it by altering at least some references in the first block 202, so that at least some communications made by the program 201 are intercepted, e.g. as described below in connection with FIG. 3.

Hooking is in itself a known technique, and requires no detailed explanation for the skilled person.

In FIG. 3 an embodiment indicating one feature of managing a program according to the invention, namely the effect of intercepting communications. A program 301 that is managed issues a write to an indirect disk write pointer 302. Normally such pointer would result the execution of an OS function that writes to disk. Instead in this case, the pointer 302 is hooked and intercepted by the managing system 303.

The managing system 303 can, for instance search for specific patterns in the communication from the program and potentially send an alarm to an external management software 306. Such pattern searching makes use of spare processor capacity in the hard ware, making the searching very fast and efficient. Almost simultaneously, and with only a minimal delay, the original write call is forwarded to the original OS function to allow the OS to carry out the write function 304 and write the data to disk 305.

In comparison to prior art systems, this provides for an almost instant, real-time monitoring of the program 301 without the need to modify the source code. Any managing steps that may be required following the intercept of the communication, e.g. sending alarms to the external management software 306, re-starting the program 301, ending the program 301, can be made without delay.

In FIG. 4 this is shown in more detail. A monitoring part 401 of the managing system comprises an interceptor 402, which receives the call from the program and places the data in a log queue 403 before forwarding the communication to the intended target at 404 (e.g. calling an OS write function).

The log queue 403 can be scanned for specific patterns, instructions, etc, by a scan engine 405, which can call on the log queue 403 to read it. The specific code or instruction to scan for can be taken from a scan rule 406. The scan rule can comprise pre-written codes, instructions, patterns etc that are to be checked for, but may also be re-writable to allow for a user to write in precise instructions or patterns pertaining what the scan engine 405 should scan for in the intercepted data.

The scan engine 405 can output data to a management solution.

We claim:

1. Method for managing a program in a hardware/software environment comprising the steps of
dynamically instrumenting the program,
intercepting communications between the program and other parts of the hardware/software environment, and
performing at least one of monitoring and controlling the program by utilising said intercept communications.

2. Method according to claim 1, wherein the step of dynamically instrumenting the program comprises the step of hooking onto the program.

3. Method according to claim 1, wherein the step of intercepting communications comprises the step of redirecting the intercepted communications.

4. Method according to claim 1, wherein the step of intercepting communications involves only intercepting communications having a specified target within the hardware/software environment.

5. Method according to claim 1, wherein the step of intercepting communications involves only intercepting communications having a specified content.

6. Method according to claim 1, wherein the step of intercepting communications involves measuring data related to use of hardware/software environment resources in connection with the program communications.

7. Computer program product comprising
a computer usable medium having computer readable code therein for
dynamically instrumenting a program in a hardware/software environment,
intercepting communications between said program and other parts of the hardware/software environment,
monitoring said intercepted communications, and
initialize an action upon detection of specified content in said intercepted communication.
